(19) United States
(12) Patent Application Publication
(10) Pub. No.: US 2026/0336344 A1
(43) Pub. Date: Oct. 29, 2026

(54) SPRING PERCH MOUNTING MECHANISM FOR JOUNCE BUMPERS

(71) Applicant: Ford Global Technologies, LLC, Dearborn, MI (US)

(72) Inventors: Prudhvi VEMULAPALLI, Livonia, MI (US); Patrick J. FRISON, Gibraltar, MI (US); Keith WESTON, Canton, MI (US); Amad WAHIB, Hamtramck, MI (US)

(21) Appl. No.: 19/188,559

(22) Filed: Apr. 24, 2025

(51) Int. Cl. B60G 13/02; B60G 9/00; B60G 11/14; B60G 11/16; B60G 11/22; B60G 11/24; B60G 11/52; B60G 11/54; B60G 13/00; B60G 13/04; B60G 15/00; B60G 15/02; B60G 15/04; B60G 17/02; B60G 21/05; B60G 21/073; B62D 33/00; F41H 7/00; F41H 9/00; F41H 11/00; F41H 13/00

(52) U.S. Cl. CPC B60G 13/02; B60G 9/00; B60G 9/003; B60G 11/14; B60G 11/16; B60G 11/22; B60G 11/24; B60G 11/52; B60G 11/54; B60G 13/00; B60G 13/001; B60G 13/003; B60G 13/005; B60G 13/006; B60G 13/008; B60G 13/04; B60G 15/00; B60G 15/02; B60G 15/04; B60G 17/021; B60G 21/05; B60G 21/052; B60G 21/073; B60G 2200/30; B60G 2202/00; B60G 2202/10; B60G 2202/12; B60G 2202/14; B60G 2202/20; B60G 2202/30; B60G 2202/31; B60G 2202/312; B60G 2202/32; B60G 2204/10; B60G 2204/12; B60G 2204/124; B60G 2204/1242; B60G 2204/12422; B60G 2204/125; B60G 2204/128; B60G 2204/14; B60G 2204/143; B60G 2204/148; B60G 2204/1482; B60G 2204/1484; B60G 2204/41; B60G 2204/4103; B60G 2204/4104; B60G 2204/41042; B60G 2204/41043; B60G 2204/41044; B60G 2204/41046; B60G 2204/43; B60G 2204/4302; B60G 2204/4304; B60G 2204/4306; B60G 2204/44; B60G 2204/4402; B60G 2204/4404; B60G 2204/82; B60G 2206/012; B60G 2206/20; B60G 2206/73; B60G 2206/8201; B60G 2206/8207; B60Y 2200/92; B62D 33/00; F41H 7/00; F41H 9/00; F41H 11/00; F41H 13/00

(57) ABSTRACT

A suspension assembly may include a suspension damper to provide damping during to a compression event, a jounce bumper to provide damping responsive to max compression of the suspension damper during the compression event, an axle operably coupled to a wheel assembly of the vehicle, and a spring perch operably coupled to the axle and configured to operably couple the jounce bumper and the axle. The jounce bumper may extend through the spring perch and operably couples to the spring perch via a flange mount.

### TECHNICAL FIELD

Example embodiments generally relate to suspension assembly components and, more particularly, relate to a spring perch mounted jounce bumper.

### BACKGROUND

Jounce bumpers are common additions to suspension assemblies to add additional damping. At the end of suspension travel, jounce bumpers complement the primary suspension dampers at full compression to provide further damping within the suspension assembly. However, the more complex suspension assemblies become, space within the suspension assembly may also become increasingly limited. Additionally, as jounce bumpers assist the suspension dampers, disposing the jounce bumpers proximate the suspension dampers may increase the efficiency of the suspension assembly's response to compression events. Therefore, a spring perch mounted jounce bumper may be desired.

### BRIEF SUMMARY OF SOME EXAMPLES

In accordance with an example embodiment, a suspension assembly of a vehicle may therefore be provided. The suspension assembly may include a suspension damper to provide damping during to a compression event, a jounce bumper to provide damping responsive to max compression of the suspension damper during the compression event, an axle operably coupled to a wheel assembly of the vehicle, and a spring perch operably coupled to the axle and configured to operably couple the jounce bumper and the axle. The jounce bumper may extend through the spring perch and operably couples to the spring perch via a flange mount.

In another example embodiment, a flange mount of a suspension assembly of a vehicle may be provided. The flange mount may include a first portion operably coupled to a jounce bumper of the suspension assembly; and a second portion operably coupled to a spring perch of the suspension assembly. The spring perch may operably couple to an axle of the vehicle and may be configured to operably couple the jounce bumper and the axle. The jounce bumper may provide damping responsive to max compression of a suspension damper during a compression event, and the jounce bumper may extend through the spring perch and operably couples to the spring perch via the flange mount.

BRIEF DESCRIPTION OF THE SEVERAL VIEWS OF THE DRAWING(S) Having thus described the invention in general terms, reference will now be made to the accompanying drawings, which are not necessarily drawn to scale, and wherein:

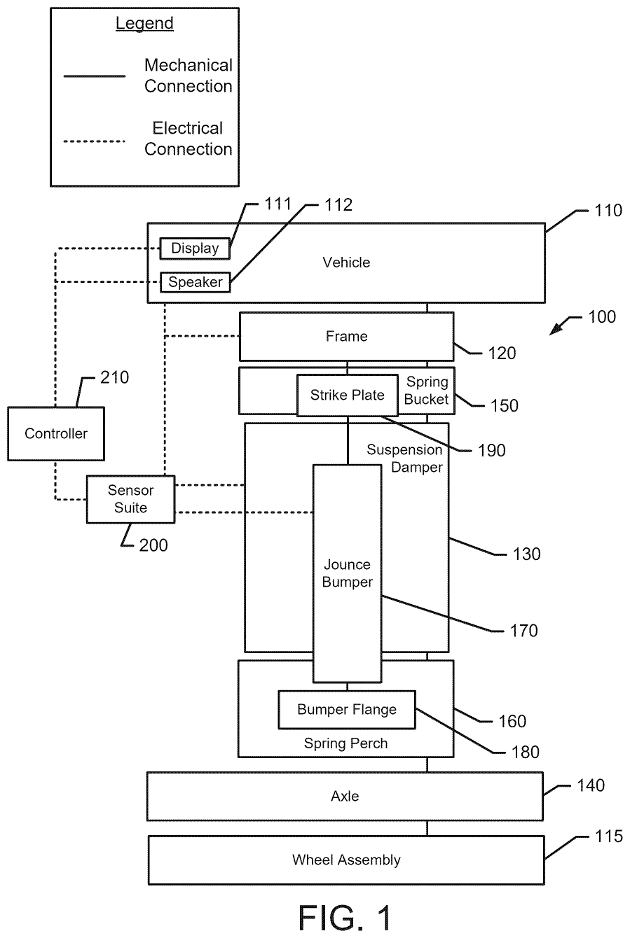

FIG. 1 depicts a block diagram of a suspension assembly for a vehicle in accordance with an example embodiment;

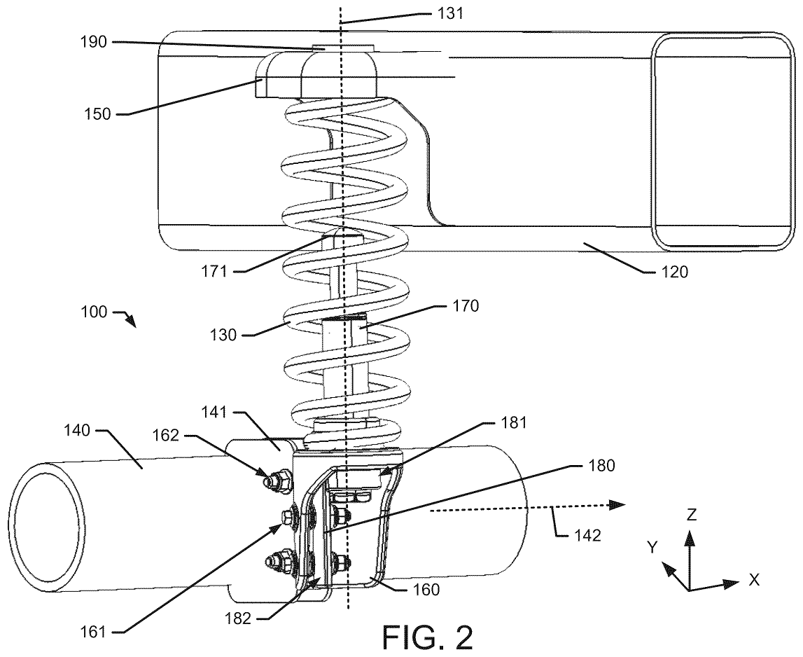

FIG. 2 illustrates a perspective view of a suspension assembly for a vehicle in accordance with an example embodiment;

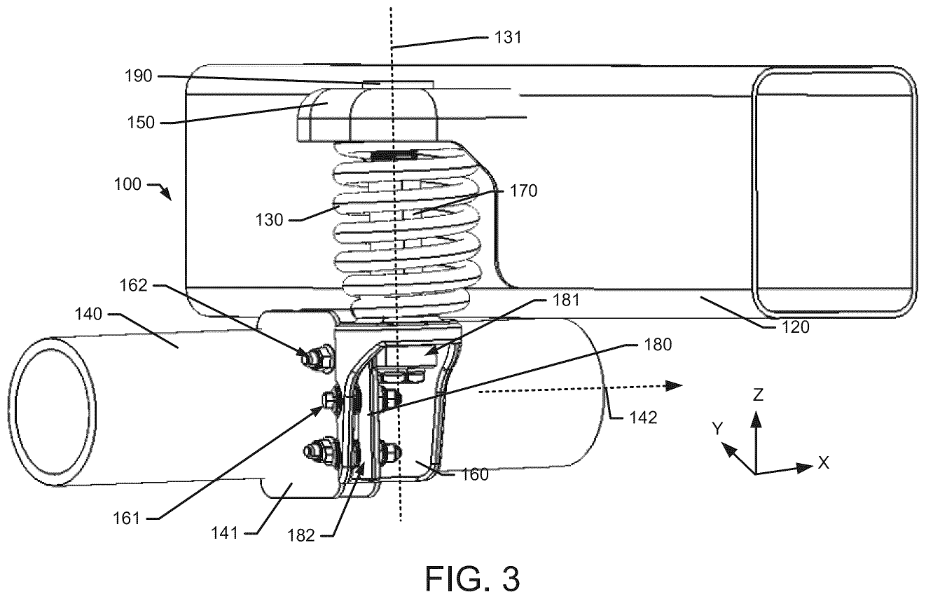

FIG. 3 depicts a perspective view of a suspension assembly for a vehicle in a jounce position in accordance with an example embodiment;

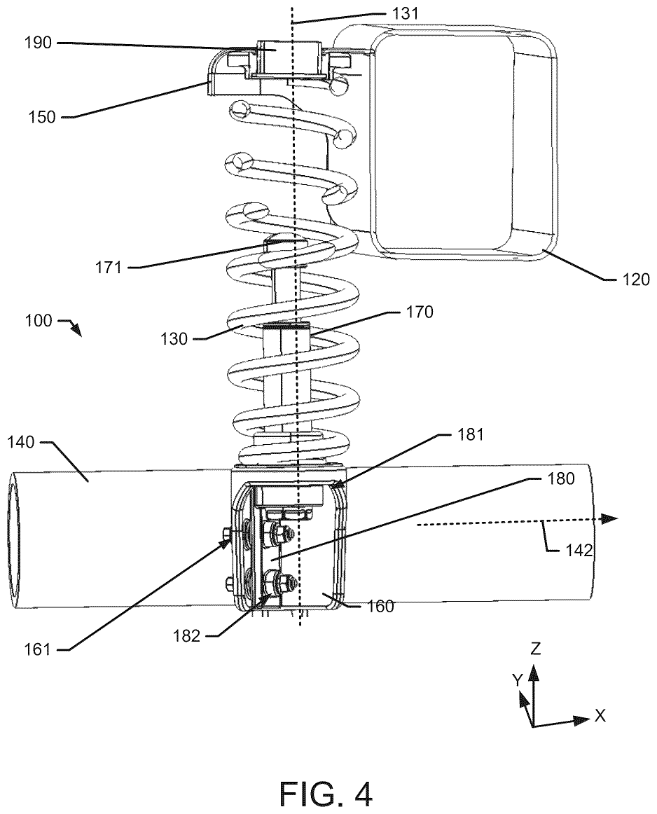

FIG. 4 illustrates a partial cross-section view of a suspension assembly for a vehicle in accordance with an example embodiment;

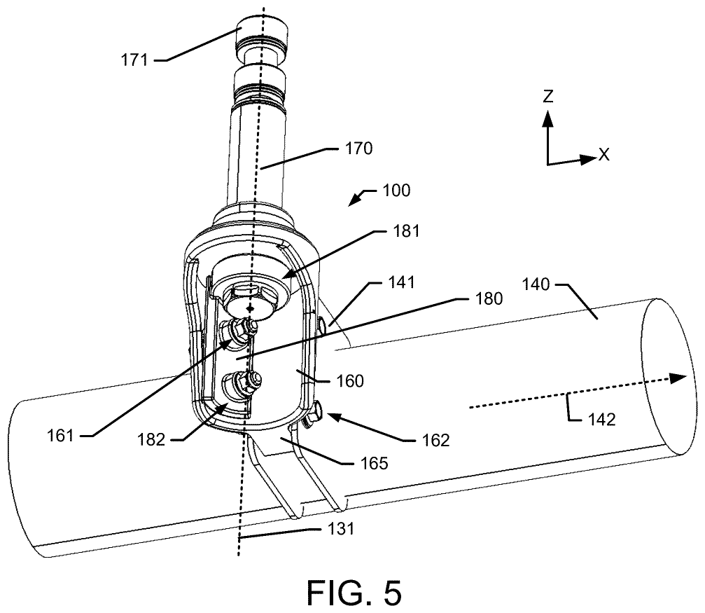

FIG. 5 depicts a lower view of a suspension assembly for a vehicle in accordance with an example embodiment; and

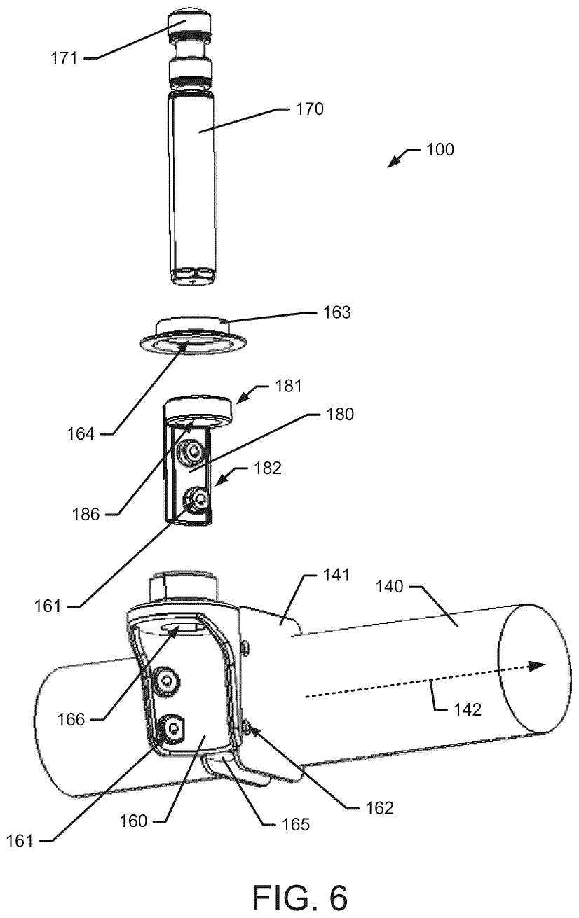

FIG. 6 illustrates an exploded view of a suspension assembly for a vehicle in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about” and “substantially” should be understood to be definite approximations that account for variations in measurements that cannot be, or as one of skill in the art would appreciate, normally are not, measured precisely. Thus, for example, a parameter that is “about” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a spring perch mounted jounce bumper to increase performance of a vehicle. As a result, the addition of the spring perch mounted jounce bumper may increase operator comfort and suspension assembly efficiency.

FIG. 1 illustrates a block diagram of a suspension assembly 100 for a vehicle 110 in accordance with an example embodiment. As seen in FIG. 1, in some cases, the vehicle 110 may include a frame 120. In an example embodiment, the frame 120 may be a chassis or body of the vehicle 110. In some cases, the chassis or frame 120 may support and form the foundation structure of the vehicle 110. In an example embodiment, the chassis and frame may be formed of one or more casted subframes, and a suspension damper 130 may be operably coupled to the chassis or frame 120 to help dampen movement of an axle 140 relative to the chassis or frame 120.

In some cases, the suspension damper 130 may be one or more vertical dampers. The suspension damper 130 may absorb or dampen the compression (jounce) and rebound of the frame 120 while the vehicle 110 is in motion. The suspension damper 130 may be referred to as and/or be a coil spring, a shock absorber, a strut, or any other suspensions member that may dampen the vehicle 110.

In some cases, the suspension assembly 100 may include and/or be coupled to an axle 140. The axle 140 may assist in operably coupling instances of a wheel assembly 115 to one another. The axle 140 may operably couple to the frame 120 via the suspension damper 130, and the suspension damper 130 may absorb forces normally exerted onto the axle 140. In an example embodiment, the suspension damper 130 may operably couple to the frame 120 via a spring bucket 150. The spring bucket 150 may receive a first end of the suspension damper 130. For example, if the suspension damper 130 is a coil spring, the spring bucket 150 may receive and anchor an end of the coil spring to limit rotation of the coil spring during compression events. In some cases, the suspension damper 130 may be operably coupled to the axle 140 via a spring perch 160. The spring perch 160 may operably couple directly to the axle 140 and may receive a second end of the suspension damper 130. For example, similar to the spring bucket 150, when the suspension damper is a coil spring, the spring perch 160 may also receive and anchor an end of the coil spring to limit rotation of the coil spring during compression events.

In an example embodiment, the suspension assembly 100 may include a jounce bumper 170. The jounce bumper 170 may be disposed proximate the suspension damper 130. In some cases, the jounce bumper 170 may have the same orientation as the suspension damper 130 in order to provide additional damping in the same direction as the suspension damper 130. For example, if the suspension damper 130 is a coil spring, the jounce bumper 170 may be disposed along a longitudinal centerline of the coil spring. The jounce bumper 170 may provide the additional damping in response to the suspension damper 130 experiencing a max compression event. A max compression event may be defined as an event in which the suspension damper 130 fully compresses and provides the maximum damping possible for the suspension damper 130 at its present settings. In some cases, the jounce bumper 170 may be a hydraulic jounce bumper.

Immediately before a max compression event (e.g. traversing uneven terrain on an off-roading path, encountering certain chassis input such as ruts or bumps, etc.) or in response to a max compression event occurring, the jounce bumper 170 may engage a portion of the frame 120 to provide the additional damping. The engagement of the jounce bumper 170 may prevent or limit the compression of the suspension assembly 100 and thus limit the contact of components of the suspension assembly 100, the axle 140, or the wheel assemblies with the frame 120 or other vehicle components. The compression of the suspension assembly 100 may be considered jounce, and the return of the suspension assembly 100 from jounce may be considered rebound. The position of the suspension assembly 100 outside of jounce and rebound may be considered the resting position. The resting position may be defined as the position of the suspension assembly 100 responsive to the vehicle 110 traversing a smooth driving surface or the position of the suspension assembly 100 according to the factory design.

In some cases, the jounce bumper 170 may be operably coupled to the axle 140. For example, the jounce bumper 170 may be operably coupled to the axle 140 via the spring perch 160. The jounce bumper 170 may operably couple to the spring perch 160 via a flange mount 180. The flange mount 180 may operably couple to or integrate with jounce bumper 170. In an example embodiment, the flange mount 180 may operably couple directly with a portion of the spring perch 160, and thus may operably couple the jounce bumper 170 to the axle 140 and the vehicle 110.

In some cases, responsive to max compression, the jounce bumper 170 may engage at a contact point disposed on the frame 120. The contact point of the jounce bumper 170 may be disposed on, integrated in, or operably coupled to the frame 120. Having a consistent contact point on the frame 120 for the jounce bumper 170 may prevent improper contact between the jounce bumper 170 and suspension assembly 100, as well as may ensure proper return to the resting position after jounce and rebound of the suspension assembly 100. In an example embodiment, the contact point may be a strike plate 190. The strike plate 190 may be operably coupled to the frame 120. In some cases, the strike plate 190 may be disposed within or operably couple to the spring bucket 150. In this regard, the strike plate 190 may be surrounded by the spring bucket 150 similarly to how the jounce bumper 170 may be surrounded by the suspension damper 130.

In some cases, the suspension assembly 100 may include the sensor suite 200 and a controller 210. The controller 210 may be configured to receive data from the sensor suite 200 and may adjust the vehicle 110 or the suspension assembly 100 based on the data from the sensor suite 200. The sensor suite 200 may include but is not limited to frame height sensors (or chassis height sensors), suspension height sensors, wheel speed sensors, accelerometers, cameras, and global positioning sensors (GPS). The sensor suite 200 may also be a component of an active suspension system and may be utilized by other vehicle assemblies and systems other than the suspension assembly 100. The controller 210 may also be configured to control or send inputs to displays 111 or speakers 112 of the vehicle 110.

In an example embodiment, the controller 210 may be a control module. In some cases, the controller 210 may include one or more control modules (i.e., sub-control modules or operably coupled to other control modules). The controller 210 may include processing circuitry that includes a processor and memory. The processing circuitry may be configured to provide electronic control of the inputs to one or more functional units of the suspension assembly 100 and to process data received at or generated by the one or more functional units of the suspension assembly 100. Thus, the processing circuitry may be configured to perform data processing, control function execution and/or other processing and management services according to an example embodiment. In some embodiments, the processing circuitry may be embodied as a semiconductor chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein. In an example embodiment, other vehicle control modules may include similar processing circuitry.

FIGS. 2 and 3 depict a profile view of the suspension assembly in accordance with an example embodiment. As shown in FIG. 2, the jounce bumper 170 may be partially or completely surrounded by the suspension damper 130 (e.g. coil spring) or other components of the suspension assembly 100 (e.g. spring perch 160, flange mount 180, etc.). In this regard, the jounce bumper 170 may, responsive to max compression of the suspension damper 130, provide additional damping at the same position the suspension damper 130 provides damping. In some cases, the suspension assembly 100 may be in jounce as seen in FIG. 3 and in rebound or rest as seen in FIG. 2. The jounce bumper 170 may contact the strike plate 190 within the spring bucket 150 in response to experiencing jounce at max or full compression as seen in FIG. 3. Otherwise, the jounce bumper 170 may not be in contact with strike plate 190 or frame 120 outside of jounce. The jounce bumper 170 may include an elastomeric end 171. The elastomeric end 171 may contact the strike plate 190 responsive to max compression. The elastomeric end 171 may be a rubber, polymer, or other elastomeric material to limit noise resulting from the contact between the jounce bumper 170 and the strike plate 190. The elastomeric end 171 may be rounded to limit contact with strike plate 190 to increase the durability of the jounce bumper 170, the strike plate 190, and the elastomeric end 171.

FIG. 4 depicts a diagonal cross-section view of the suspension assembly in accordance with an example embodiment. FIGS. 5 and 6 illustrates a lower view and an exploded view respectively of the suspension assembly in accordance with an example embodiment. FIG. 4 shows a partial cross-section of the suspension damper 130, spring bucket 150, strike plate 190, and frame 120. As seen in FIG. 4, the strike plate 190 may be integrated within the spring bucket 150. The strike plate 190 may be disposed along the center of the suspension damper 130. A center reference line 131 may represent the center or the longitudinal centerline of the suspension damper 130. In addition to the strike plate 190, the spring bucket 150 and the jounce bumper 170 may be disposed and/or aligned with a common axis and/or the longitudinal centerline of the suspension damper 130.

Additionally, the spring perch 160 and the flange mount 180 may also be at least partially aligned with the longitudinal centerline of the suspension damper 130. The spring perch 160 and the flange mount 180 may operably couple to one another via a first coupling assembly 161. The first coupling assembly 161 may include a set of nuts and bolts to removable operably couple the spring perch 160 and flange mount 180 to each other. The set of nuts and bolts may extend and secure through respective receiving orifices disposed on both the spring perch 160 and flange mount 180.

In some cases, the spring perch 160 may operably couple to the axle 140 via a second coupling assembly 162. The second coupling assembly 162 may also include a set of nuts and bolts to removably operably couple the spring perch 160 and the axle 140. The spring perch 160 may operably couple to the axle 140 via a spring perch bracket 141 disposed on the axle 140. The spring perch bracket 141 may integrate with or operably couple to the axle 140. The spring perch bracket 141 may extend substantially perpendicular to the direction of axle extension 142, and the spring perch bracket 141 may include a number of receiving orifices to receive the second coupling assembly 162. The spring perch bracket 141 may be a c-shaped bracket and sides of the c-shaped bracket may extend around an axle coupling portion 165 of the spring perch 160. In other words, the axle coupling portion 165 may be sandwiched in between sides of the spring perch bracket 141. In some cases, the spring perch bracket 141 may be a single, flat-face extension that extends substantially parallel with the axle coupling portion 165.

The spring perch 160 and the flange mount 180 may have a spring perch jounce bumper receiving orifice 166 and a flange mount jounce bumper receiving orifice 186 respectively. The spring perch jounce bumper receiving orifice 166 and the flange mount jounce bumper receiving orifice 186 may align and receive the jounce bumper 170 along the center reference line 131. The jounce bumper 170 may be snug-fit within spring perch jounce bumper receiving orifice 166 to prevent noise and increase stability.

The flange mount jounce bumper receiving orifice 186 may be integrated with a body portion of the jounce bumper 170 to integrate the flange mount 180 to jounce bumper 170. For example, the flange mount jounce bumper receiving orifice 186 may be welded to the jounce bumper 170. In this regard, the jounce bumper 170 may be anchored and secured to the axle 140 via the spring perch 160 and flange mount 180. Additionally, in some cases, the jounce bumper 170 and flange mount 180 may be integrated during manufacturing. In this regard, the instillation and/or replacement of the jounce bumper 170 and flange mount 180 within the suspension assembly 100 may occur easily and efficiently. As the jounce bumper 170 may extend through both the spring perch jounce bumper receiving orifice 166 and the flange mount jounce bumper receiving orifice 186, the additional support to the jounce bumper 170 may limit side loads experienced by the jounce bumper 170.

In some cases, the flange mount 180 may include a first flange mount portion 181 and a second flange mount portion 182. The first flange mount portion 181 may include the flange mount jounce bumper receiving orifice 186, and the second flange mount portion 182 may include the respective receiving orifices to operably couple the flange mount 180 and the spring perch 160 via a bolt inserted therethrough. The first flange mount portion 181 may be disposed at an end of the second flange mount portion 182 disposed proximate the suspension damper 130. The flange mount 180 may not overlap with the suspension damper 130 in the Z-direction.

The spring perch 160 and the flange mount 180 may extend substantially parallel to one another. Both the spring perch 160 and the flange mount 180 may be curved. For example, both the spring perch 160 and the second flange mount portion 182 may be concave-shaped. Thus, the spring perch 160 and second flange mount portion 182 may share the same degree of concavity. In an example embodiment, the spring perch 160 and the second flange mount portion 182 may not extend the same amount in a direction around the center reference line 131. The second flange mount portion 182 may extend in the direction around the center reference line 131 long enough to ensure stability of its respective receiving orifices (e.g. by ensuring enough material is disposed around every side of the receiving orifice to permit robust support for bolted connection). In some cases, the spring perch 160 may extend a greater distance in the direction around the center reference line 131 than second flange mount portion 182. The spring perch 160 may not extend fully around the center reference line 131, as additional material required for full extension may add unnecessary weight, may limit access the flange mount 180 and jounce bumper 170 for replacement or installation purposes, and may not add any substantial performance increase. For example, the suspension assembly 100 may allow for instillation and/or replacement of the jounce bumper 170 and flange mount 180 without needing to remove or modify the other components of the suspension assembly 100. In this regard, the suspension damper 130, the axle 140, the spring bucket 150, and the spring perch 160 may not be adjusted to install the jounce bumper 170.

The concave portion of the spring perch 160 may extend between 90 degrees (π/2 radians) to 180 degrees (π radians) in the direction around the center reference line 131. The second flange mount portion 182 may extend between 15 degrees and 45 degrees in the direction around the center reference line 131. In this regard, the flange mount 180 may be disposed completely within a profile of the spring perch 160, so that the flange mount 180 completely overlaps with the spring perch 160 in the X-direction and the Z-direction. In some cases, the first coupling assembly 161 and the second coupling assembly 162 may be phased or offset from one another. For example, the first coupling assembly 161 and the second coupling assembly 162 may be oriented or phased 45 degrees from one another.

In an example embodiment, the spring perch 160 may also include a spring rest 163. The spring rest 163 may be disposed on an upper portion of the spring perch 160 disposed proximate the suspension damper 130. The spring rest 163 may include a spring rest jounce bumper receiving orifice 164 to receive the jounce bumper 170. The spring rest 163 may decrease wear of the spring perch 160 from the suspension damper 130, and the spring rest 163 may be easily replaceable compared to the spring perch 160.

In some cases, the components of the suspension assembly 100 (e.g. frame 120, axle 140, spring bucket 150, spring perch 160, flange mount 180, strike plate 190, etc.) may be made of aluminum, steel, metal alloys, or other sturdy materials capable of withstanding vehicle loads. Some components or some portions of components (e.g. elastomeric end 171, strike plate 190, spring rest 163, etc.) may also be formed or covered with elastomeric materials to prevent metal-on-metal contact, which may result in unwanted noise for an operator or passenger of the vehicle 110.

In some cases, the center reference line 131 may extend along the Z-direction of the vehicle 110 and may be substantially perpendicular to the direction of axle extension 142. However, in an example embodiment, the center reference line 131 may be slightly angled away from the Z-direction of the vehicle 110. The angle of the center reference line 131 may be between 10 degrees and 40 degrees relative the Z-direction of the vehicle 110. In some cases, the center of the spring perch 160 and the spring bucket 150 may not be aligned with each other and may cause a slight bend in the suspension damper 130.

In some cases, the controller 210 may utilize sensor data from the sensor suite 200 disposed within or proximate to the suspension assembly 100 to send indications to an operator of the vehicle 110 that the jounce bumper 170 may engage with the strike plate 190. For example, the sensor suite 200 may include a frame height sensor. The frame height sensor may collect frame high data determined via monitoring the height of the frame 120 relative the suspension assembly 100 and/or the wheel assemblies. The controller 210 may use the frame height data to determine if a max compression event may occur (e.g. will the jounce bumper 170 engage with the strike plate 190, will the suspension damper 130 fully compress, etc.). Responsive to determining the max compression event will occur, the controller 210 may further determine a time until the occurrence of the max compression event (e.g. preemptively determine max compression).

Utilizing the time until the occurrence of the max compression event, the controller 210 is configured to transmit an indication to the operator or trigger an additional system of the vehicle 110 at an exact time of the max compression event. In some cases, the indication may be an auditory indication utilizing at least one of the speakers 112 of the vehicle 110. The auditory indication may include but is not limited to a tone, chime, ring, music, or jingle to indicate the jounce bumper 170 engaged with the strike plate 190. In some cases, the indication may be visual indication utilizing at least one of the displays 111 of the vehicle 110. The visual indication may include but is not limited to an animation or message on a heads-up display.

In an example embodiment, the additional systems of the vehicle 110 may be a camera system or capture system. The camera system or capture system may use various internal and external cameras (e.g. dash camera, reverse camera, side cameras, rearview cameras, cabin cameras, etc.) of the vehicle 110 to capture events of the vehicle 110. In some cases, the cameras may be included in the sensor suite 200. At the time of the max compression event, the controller 210 may be configured to trigger the camera system or the capture system to collect videos or pictures of the environment or cabin at the exact time of max compression. For example, the camera system or capture system may record another vehicle traversing an off-road path immediately behind the vehicle 110 utilizing the reverse camera. In some cases, the controller 210 may be configured to start the camera system or capture system for a time period before and after the max compression event to record the full reaction to the vehicle event that caused the max compression event.

A suspension assembly of a vehicle may therefore be provided. The suspension assembly may include a suspension damper to provide damping during to a compression event, a jounce bumper to provide damping responsive to max compression of the suspension damper during the compression event, an axle operably coupled to a wheel assembly of the vehicle, and a spring perch operably coupled to the axle and configured to operably couple the jounce bumper and the axle. The jounce bumper may extend through the spring perch and operably couples to the spring perch via a flange mount.

The suspension assembly of a vehicle of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, the suspension damper may include a coil spring, and responsive to the coil spring being operably coupled to the spring perch, the jounce bumper may extend along the center of the coil spring in a Z-direction of the vehicle. In some cases, the flange mount and the coil spring may not overlap. In an example embodiment, the flange mount may be completely disposed within a profile of spring perch. In some cases, the spring perch may be operably coupled to the axle via a first fastening arrangement, and the flange mount may be operably coupled to the spring perch via a second fastening arrangement. In some cases, the spring perch may be disposed between the axle and the flange mount. In an example embodiment, the flange mount may be integrally formed with the jounce bumper prior to the flange mount operably coupling to the spring perch. In some cases, the jounce bumper may operably couple to the flange mount via a receiving orifice of the flange mount. In an example embodiment, the spring perch may be angled between 5-30 degrees away from the axle relative to a Z-direction of the vehicle extending through the axle. In some cases, a spring bucket is operably coupled to a frame of the vehicle, and the spring bucket may be aligned along a common axis with spring perch and disposed to interface with the jounce bumper. In an example embodiment, the spring bucket may include a strike plate aligned along the common axis with the spring perch and disposed to interface with the jounce bumper, and the strike plate may be configured to receive an elastomeric end of the jounce bumper responsive to the vehicle experiencing max compression. In some cases, the flange mount may be disposed at a concave portion of the spring perch. In an example embodiment, the concave portion may extend between π/2 and π radians.

A flange mount of a suspension assembly of a vehicle may be provided. The flange mount may include a first portion operably coupled to a jounce bumper of the suspension assembly; and a second portion operably coupled to a spring perch of the suspension assembly. The spring perch may operably couple to an axle of the vehicle and may be configured to operably couple the jounce bumper and the axle. The jounce bumper may provide damping responsive to max compression of a suspension damper during a compression event, and the jounce bumper may extend through the spring perch and operably couples to the spring perch via the flange mount.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

Such operations described herein should always be implemented and/or performed in accordance with the owner's manual and safety guidelines.

1. (canceled)

2. (canceled)

3. A suspension assembly of a vehicle, the suspension assembly comprising:
a suspension damper to provide damping during to a compression event;
a jounce bumper to provide damping responsive to max compression of the suspension damper during the compression event;
an axle operably coupled to a wheel assembly of the vehicle; and
a spring perch operably coupled to the axle and configured to operably couple the jounce bumper and the axle,
wherein the jounce bumper extends through the spring perch and operably couples to the spring perch via a flange mount,
wherein the suspension damper comprises a coil spring,
wherein responsive to the coil spring being operably coupled to the spring perch, the jounce bumper extends along a center of the coil spring,
wherein the flange mount and the coil spring do not overlap in a Z-direction of the vehicle.

4. The suspension assembly of claim 3, wherein the flange mount is completely disposed within a profile of the spring perch.

5. The suspension assembly of claim 3, wherein the spring perch is operably coupled to the axle via a first fastening arrangement, and
wherein the flange mount is operably coupled to the spring perch via a second fastening arrangement.

6. The suspension assembly of claim 3, wherein the spring perch is disposed between the axle and the flange mount.

7. The suspension assembly of claim 3, wherein the flange mount is integrally formed with the jounce bumper prior to the flange mount operably coupling to the spring perch.

8. The suspension assembly of claim 3, wherein the jounce bumper operably couples to the flange mount via a receiving orifice of the flange mount.

9. The suspension assembly of claim 3, wherein the spring perch is angled between 5-30 degrees away from the axle relative to a Z-direction of the vehicle extending through the axle.

10. The suspension assembly of claim 3, wherein a spring bucket is operably coupled to a frame of the vehicle, and
wherein the spring bucket is aligned along a common axis with the spring perch and disposed to interface with the jounce bumper.

11. The suspension assembly of claim 10, wherein the spring bucket includes a strike plate aligned along the common axis, and
wherein the strike plate is configured to receive an elastomeric end of the jounce bumper responsive to the vehicle experiencing max compression.

12. The suspension assembly of claim 3, wherein the flange mount is disposed at a concave portion of the spring perch.

13. The suspension assembly of claim 12, wherein the concave portion extends between π/2 and π radians.

14. A flange mount of a suspension assembly of a vehicle, the flange mount comprising:
a first portion operably coupled to a jounce bumper of the suspension assembly; and
a second portion operably coupled to a spring perch of the suspension assembly,
wherein the spring perch operably couples to an axle of the vehicle and is configured to operably couple the jounce bumper and the axle,
wherein the jounce bumper provides damping responsive to max compression of a suspension damper during a compression event, and
wherein the jounce bumper extends through the spring perch and operably couples to the spring perch via the flange mount,
wherein the suspension damper comprises a coil spring, and
wherein responsive to the coil spring being operably coupled to the spring perch, the first portion and the second portion are disposed on an opposite side of the spring perch than the coil spring,
wherein responsive to the coil spring being operably coupled to the spring perch, the jounce bumper extends along a center of the coil spring.
wherein the flange mount and the coil spring do not overlap in a Z-direction of the vehicle.

15. (canceled)

16. (canceled)

17. The flange mount of claim 14, wherein the flange mount is completely disposed within a profile of spring perch.

18. The flange mount of claim 14, wherein the spring perch is operably coupled to the axle via a first fastening arrangement, and
wherein the flange mount is operably coupled to the spring perch via a second fastening arrangement.

19. The flange mount of claim 14, wherein the spring perch is disposed between the axle and the flange mount.

20. The flange mount of claim 14, wherein the flange mount is integrally formed with the jounce bumper prior to the flange mount operably coupling to the spring perch.
